(19) United States
(12) Patent Application Publication
(10) Pub. No.: US 2024/0420211 A1
(43) Pub. Date: Dec. 19, 2024

(54) INTELLIGENT PRODUCT GUIDANCE BASED ON SPACE AVAILABILITY

(71) Applicant: INTERNATIONAL BUSINESS MACHINES CORPORATION, ARMONK, NY (US)

(72) Inventors: Wesley Ip, Arlington, TX (US); Logan Bailey, Atlanta, GA (US); Alexandra M. Isaly, Lighthouse Point, FL (US); RYAN Michael SPARKS, Norman, OK (US); Zachary A. Silverstein, Georgetown, TX (US)

(21) Appl. No.: 18/335,454

(22) Filed: Jun. 15, 2023

(51) Int. Cl. G06Q 30/0601; G06T 19/00

(52) U.S. Cl. CPC G06Q 30/0631; G06Q 30/0623; G06T 19/006

(57) ABSTRACT

According to one embodiment, a method, computer system, and computer program product for managing a physical storage system of a user is provided. The present invention may include identifying a physical item that a user has selected for acquisition; selecting one or more storage areas of a plurality of storage areas comprising the physical storage system to store the item in based on a category associated with the item; determining an amount of storage space required to store the item based on dimensions of the item; comparing the determined amount of storage space against a current amount of free storage space within the one or more selected storage areas; and responsive to identifying that the determined amount of storage space exceeds the current amount of free space based on the comparing, generating an alert to the user.

### BACKGROUND

The present invention relates, generally, to the field of computing, and more particularly to technology-assisted physical storage management.

The concept of technology-assisted physical storage management refers to the use of technological tools and systems to optimize the management and organization of physical storage spaces. It involves the application of various technologies to enhance efficiency, accuracy, and accessibility in storing, tracking, and retrieving items or assets within a physical storage environment such as a storage unit, warehouse, or private home.

### SUMMARY

According to one embodiment, a method, computer system, and computer program product for managing a physical storage system of a user is provided. The present invention may include identifying a physical item that a user has selected for acquisition; selecting one or more storage areas of a plurality of storage areas comprising the physical storage system to store the item in based on a category associated with the item; determining an amount of storage space required to store the item based on dimensions of the item; comparing the determined amount of storage space against a current amount of free storage space within the one or more selected storage areas; and responsive to identifying that the determined amount of storage space exceeds the current amount of free space based on the comparing, generating an alert to the user.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a physical storage management process according to at least one embodiment;

FIG. 3 is an operational flowchart illustrating a physical storage management process according to at least one embodiment;

FIG. 4 illustrates an exemplary physical storage system, according to at least one embodiment; and

FIG. 5 is an illustration of an exemplary use-case of a physical storage management system according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to technology-assisted physical storage management. The following described exemplary embodiments provide a system, method, and program product to, among other things, track physical storage available to a user and provide real-time analysis regarding accommodation of items acquired by the user.

As previously described, technology-assisted physical storage management refers to the use of technological tools and systems to optimize the management and organization of physical storage spaces. A persistent problem faced by many individuals purchasing items in a physical commercial transaction, such as purchasing groceries at the grocery store, is the problem of where to store purchased items, and whether there is enough storage space available to accommodate the purchased items. Various technologies, such as internet of things devices, digital twins, and augmented reality may be leveraged in combination to guide the user at the time of purchase and inform whether there is sufficient storage space available to the user for storing any individual item that a user might wish to purchase. As such, it may be advantageous to, among other things, implement a system that leverages sensor data from IoT-equipped storage spaces available to a user to create a digital twin of the user's storage spaces, utilize the digital twin to predict whether items may be accommodated within currently available storage space, inform the user in real-time whether a given item may be accommodated, and visualize to a user, using augmented reality, both the storage space and where and how the item may be accommodated within the storage space. Therefore, the present embodiment has the capacity to improve the technical field of technology-assisted physical storage management by improving the efficiency with which available storage space is used by efficiently fitting items into allotted storage spaces, and increasing the detail and fidelity of analysis provided to a user regarding available storage space. These technical improvements in turn stand to realize the more general advantages of keeping the user informed in real-time as to what items to acquire and what storage space is available, reducing overall space needed for storage, reducing wastage of perishable or fragile items acquired in excess of properly equipped storage spaces, et cetera.

According to at least one embodiment, the invention is a physical storage system comprising one or more storage spaces equipped with Internet of Things (IoT) sensors capable of providing information regarding the current available and occupied storage volume of the storage space.

Internet of Things (IoT) refers to a network of interconnected physical devices, objects, and systems that are embedded with sensors, software, and network connectivity, allowing them to collect and exchange data. The technology of IoT enables these devices to communicate with each other and with central systems, leading to a seamless integration of the physical and digital worlds. IoT devices can range from everyday objects like thermostats, lights, and wearables to industrial equipment, vehicles, and infrastructure. These devices are equipped with various sensors such as temperature, motion, proximity, or environmental sensors, which gather data about their surroundings. IoT devices are connected to the internet or private networks, enabling data transmission and communication. They may utilize technologies like Wi-Fi, Bluetooth, cellular networks, or low-power, wide-area networks (LPWAN) such as LoRaWAN or NB-IoT. IoT devices exchange data with each other and with cloud-based platforms or central systems. This communication can happen in real-time or intermittently, depending on the application requirements and connectivity options. IoT data is often processed and stored in cloud-based platforms, which provide the necessary infrastructure and scalability to handle the vast amounts of data generated by IoT devices. Cloud computing enables data analysis, storage, and remote management of IoT systems. IoT data can be analyzed using advanced analytics and AI techniques to extract meaningful insights, identify patterns, and make predictions. These capabilities enable automation, optimization, and intelligent decision-making in various IoT applications.

According to at least one embodiment, the invention is a system and method for managing storage space in a physical storage system by modeling one or more IoT-equipped storage spaces in the form of a digital twin, identifying items that a user has selected for acquisition, determining an amount of storage space required to store the item based on the dimensions of the item, comparing the determined amount of storage space required to store the item against the available storage space available within the physical storage system, and determining where the items may be stored within the physical storage system based on the digital twin.

A digital twin may be a virtual representation or digital counterpart of a real-world entity such as a physical object or system, which may range in complexity from a simple device to a complex system such as a machine, a building, a manufacturing plant, or even a city; the digital twin is a digital replica that mirrors the real-world entity in terms of its characteristics, behavior, and interactions. Data is collected from the real-world entity using sensors, IoT devices, or other data sources. This data includes information about the entity's state, performance, behavior, and environmental conditions. The acquired data is used to create a digital model or representation of the real-world entity representing the entity's geometry, structure, properties, and other relevant attributes. The digital twin is continuously updated and synchronized with the real-world entity such that any changes made to the real-world entity are detected, transmitted to, and incorporated into the digital twin at regular intervals and/or in real time or near-real-time, providing an accurate and up-to-date representation of the real-world entity. The digital twin may be accessed and managed remotely by the user, allowing for real-time monitoring, control, and collaboration.

In embodiments, the invention may be a system and method for visualizing the contents of a physical storage system to a user utilizing mixed reality.

Mixed reality represents the technology of merging real and virtual worlds such that physical and digital objects co-exist and interact in real time. Mixed reality does not exclusively take place in either the physical or virtual worlds but is a hybrid of reality and virtual reality; as such, mixed reality describes everything in the reality-virtuality continuum except for the two extremes, namely purely physical environments and purely virtual environments. Accordingly, mixed reality includes augmented reality (AR) and virtual reality (VR). As previously described, augmented reality is a modern computing technology that uses software to generate images, sounds, haptic feedback, and other sensations which are integrated into a real-world environment to create a hybrid augmented reality environment, comprising both virtual and real-world elements. Virtual reality is a modern computing technology that creates a virtual environment that fully replaces the physical environment, such that a user experiencing a virtual reality environment cannot see objects or elements of the physical world; however, the virtual reality environment is anchored to real-world locations, such that the movement of players, virtual objects, virtual environmental effects and elements all occur relative to corresponding locations in the physical environment. Augmented reality is distinct from virtual reality in that an augmented reality environment augments the physical environment by overlaying virtual elements onto the physical environment, whereas a virtual reality environment fully replaces the physical environment with a virtual environment to completely immerse the user in a computer-generated world. In other words, a user within a virtual reality environment cannot see any real-world objects or environments, while a user within an augmented reality environment can see both the physical environment and virtual elements.

The user may experience an augmented reality environment through the use of an augmented reality device, which may be a general-purpose display-equipped computing device, such as a cell phone or tablet, or may comprise more specialized equipment, typically in the form of glasses or headsets where computer generated elements are overlaid onto a view of the real world by being projected or mapped onto a lens in front of a user's eyes. With the help of computer augmentation, information about the surrounding world of the user, as well as other digital elements overlaid onto the world, becomes interactive and digitally manipulable. An augmented reality device differs from a virtual reality device in that an augmented reality device must be equipped with a camera that is mounted, held, or otherwise positioned coaxially to a user's central axis of vision such that the feed from the camera approximates and overlaps the user's cone of vision; the feed from this camera is either modified with virtual elements and displayed to the user, or used to determine where in the user's vision virtual elements should be placed, and then projected onto a prism or glass substrate disposed in front of the user's eyes. A virtual reality device, by contrast, has no need of outward-facing cameras except to identify the location of the device, and often employees other means of positioning such as infrared sensors.

While using an augmented reality device to experience an augmented reality environment, a user can see and interact with virtual objects overlaid onto the user's physical environment. A common method of interacting with virtual objects in both augmented reality environments and virtual reality environments is to first extrapolate a line from a controller; any virtual object that the extrapolated line touches may be selected, and may be manipulated at a distance, summoned, modified, or otherwise interacted with by the user. However, the art has struggled with selecting physical objects in the augmented reality environment; the reason for this is that the augmented reality or virtual reality system creates and controls virtual objects, and so has access to all data regarding virtual objects and can easily facilitate any desired interaction between a user and the virtual object. However, an augmented reality system has much more limited power over physical objects; the system cannot manipulate the physical object as it would a virtual object and must resort to less direct means to facilitate interaction between the user and the physical object. Nevertheless, it may be desirable for a user of an augmented reality system to select a physical object in an augmented reality environment, as a user may desire to interact with the physical object at a distance.

According to an aspect of the invention, there is provided a processor-implemented method for managing a physical storage system of a user, which may include identifying a physical item that a user has selected for acquisition; selecting one or more storage areas of a plurality of storage areas comprising the physical storage system to store the item in based on a category associated with the item; determining an amount of storage space required to store the item based on dimensions of the item; comparing the determined amount of storage space against a current amount of free storage space within the one or more selected storage areas; and, responsive to identifying that the determined amount of storage space exceeds the current amount of free space based on the comparing, generating an alert to the user. This allows the system to dynamically assess whether an item will fit into the user's physical storage system when the user selects the item but prior to the user actually purchasing the item, allowing the user to avoid purchasing items that the user does not have space to store.

In embodiments, the alert may include a recommendation to not purchase the item, a recommendation to purchase a smaller sized item, or a recommendation to purchase an alternate item of dimensions accommodated by the amount of free storage space within the one or more selected storage areas or the physical storage system. Recommending alternate items enables the user to quickly adapt to low remaining storage space and quickly identify smaller or better-fitting equivalents to the item to acquire the same functionality while still having sufficient space to store the item.

In embodiments, responsive to identifying that the determined amount of storage space exceeds the current amount of free space based on the comparing, identifying one or more reorganizations of one or more currently stored objects within the one or more selected storage areas that would enable the one or more selected storage areas to accommodate the item. Identifying reorganizations of currently stored objects allows the user to make maximum use of the storage system by moving currently stored objects around within the physical storage area to free up additional space and accommodate the selected item.

In embodiments, the invention may utilize mixed reality to display to the user the selected item within the selected one or more storage areas. Mixed reality visualizations allow the user to quickly see and comprehend where and how an object should be stored to fit into the available free storage space and give the user an idea of where and how to organize the item when storing it.

In embodiments, the invention may comprise determining an amount of storage space required to store the item in an unpackaged or reconfigured state. Factoring in the various possible states of the item allows the system to select the state that best fits, allowing an item to fit into the available storage space even where one or more states of the object cannot fit within the selected storage area.

In embodiments, the invention may include generating a digital model of the item based on the dimensions and modeling the digital model of the item within a digital twin of the selected one or more storage areas, where the digital twin of the selected one or more storage areas comprises one or more currently stored objects. Simulating the digital model of the item within the digital twin enables the system to provide accurate and up-to-date assessments of whether and how the item will fit within the physical storage system.

In embodiments, the digital twin of the selected storage areas may comprise other items previously selected for acquisition by the user. Updating the digital twin with selected items that have been selected but have not yet been stored allows the system to simulate the effect the previously selected items have on the available storage space, such that the system may be able to accurately assess whether and how items will fit within the storage system even when multiple items have been acquired during a single shopping session, and prevent the user from accidentally acquiring more items that can fit in the physical storage system during a single shopping session.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor, as distinct from the physical storage areas and physical storage systems referred to herein which store physical real-world objects. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to track physical storage available to a user and provide real-time analysis regarding accommodation of items acquired by the user.

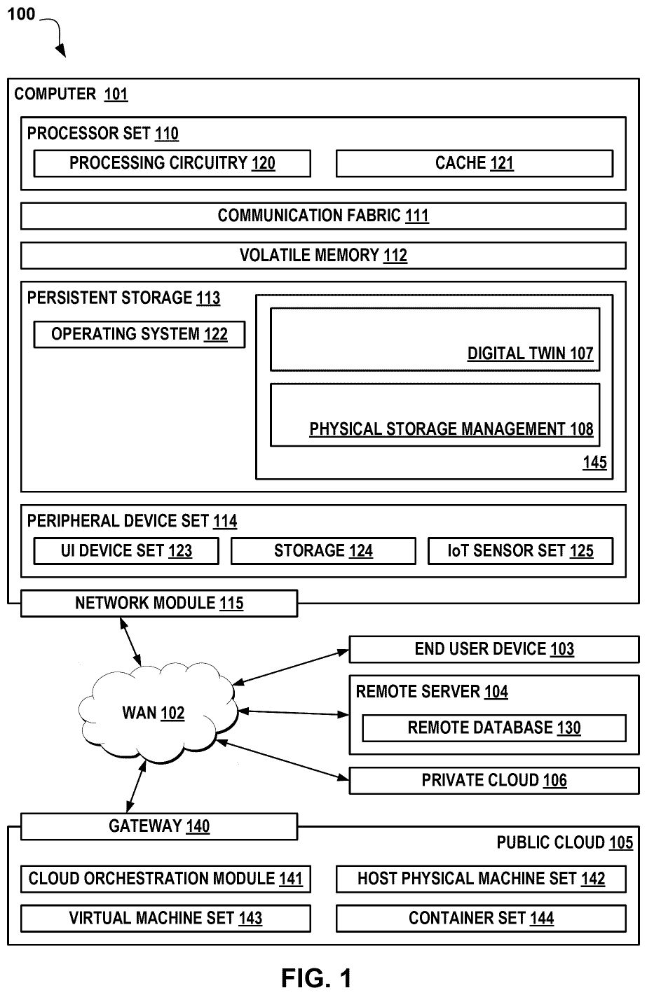

Referring now to FIG. 1, computing environment 100 contains an example of an environment for the execution of at least some of the computer code involved in performing the inventive methods, such as code block 145, which may comprise digital twin program 107 and physical storage management program 108. In addition to code block 145, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code block 145, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code block 145 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in code block 145 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles or smart watches), keyboard, mouse, printer, touchpad, game controllers, and haptic devices. Devices of UI device set 123 may comprise a mixed-reality device such as a headset or display, and UI device set may include mixed-reality devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications such as in a physical storage system. For example, one sensor may be a LiDAR sensor, and another sensor may be a visual spectrum or infrared camera.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to the present embodiment, the digital twin 107 may be a digital representation of the physical storage spaces comprising the physical storage system. Physical storage spaces may be real-world spaces designated for storing physical objects which are equipped with at least one IoT device that provides sensor data regarding the number and arrangement of objects stored within the storage spaces, and which IoT device is capable of communicating gathered information to the physical storage management program 108 at regular intervals, and/or in real-time or near-real-time. Physical storage spaces may be as simple as an area designated on the ground for placing objects within, or as complex as automated, multi-level warehouses, and may range in size from storage tins to backpacks to individual shelves to cabinets to refrigerators to closets to storage units to basements to entire barns and may be even larger. All physical storage spaces associated with a single user or group of users may be referred to as a physical storage system. The physical storage management program 108 may utilize sensor data from the IoT devices to fashion the digital twin 107 of the physical storage system, which may comprise a virtual model mimicking the geometry, structure, properties, internal volume, and other relevant attributes of the physical storage space, as well as the geometry, structure, properties, arrangement, position, volume, et cetera of any physical objects stored within the physical storage space. The physical storage management program 108 may continually update the digital twin 107 of the physical storage system as new data is received from the IoT devices, to keep the state of the digital twin 107 synchronized and identical to the state of the real-world physical storage space. In embodiments of the invention, the digital twin 107 may be stored within or by any number or combination of devices including computer 101, end user device 103, remote server 104, private cloud 106, and/or public cloud 105, peripheral device set 114, and server 112 and/or on any other device connected to WAN 102. In embodiments of the invention, the digital twin 107 may be created by and/or maintained by physical storage management program 108, and may be a component or module of, in communication with, or otherwise interoperating with the physical storage management program 108.

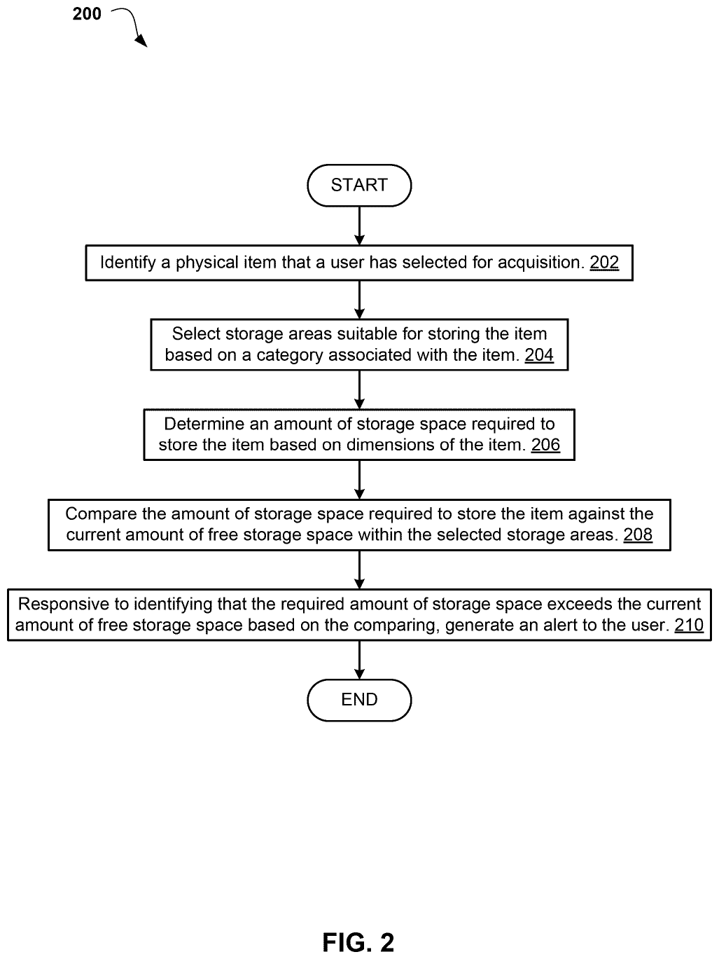

According to the present embodiment, the physical storage management program 108 may be a program enabled to track physical storage available to a user and provide real-time analysis regarding accommodation of items acquired by the user. The physical storage management program 108 may, when executed, cause the computing environment 100 to carry out a physical storage management process 200. The physical storage management process 200 may be explained in further detail below with respect to FIG. 2. In embodiments of the invention, the physical storage management program 108 may create and/or maintain a digital twin 107. In embodiments of the invention, the physical storage management program 108 may be stored and/or run within or by any number or combination of devices including computer 101, end user device 103, remote server 104, private cloud 106, and/or public cloud 105, peripheral device set 114, and server 112 and/or on any other device connected to WAN 102. Furthermore, physical storage management program 108 may be distributed in its operation over any number or combination of the aforementioned devices.

Referring now to FIG. 2, an operational flowchart illustrating a physical storage management process 200 is depicted according to at least one embodiment. At 202, the physical storage management program 108 may identify a physical item that a user has selected for acquisition. Here, the physical storage management program 108 may recognize that the user has selected a physical item to acquire. In embodiments, the user may select a physical item by scanning an identification tag on the physical item with a handheld device, for instance by scanning a barcode on the item with a handheld barcode scanner or scanning a QR code on the item with the camera of a mobile device. In embodiments, the user may select a physical item by entering a name and/or identification number for the object into physical storage management program 108. In embodiments, for example where the item is visible to a camera such as a camera integrated into a headset worn by the user or deployed within the user's environment, the user may select a physical item by placing the item into a pre-designated location such as a shopping cart, checkout counter, shopping bag, et cetera, in which case the camera may record images or video of the item; the physical storage management program 108 may then perform image processing techniques on the sensor feed from the camera, and/or may conduct optical character recognition on text printed or written on the item, to detect the selected item. In embodiments, for example where the physical storage management program 108 uses mixed reality, the user may select an object by interacting with a virtual graphical and/or textual element, such as a “buy” button or icon, overlayed onto or nearby to the physical item, or placed onto or near a digital representation of the physical item.

Once an item has been selected by the user, the physical storage management program 108 may identify the selected item. In embodiments, for example where a user has provided physical storage management program 108 with a name and/or identifying information for the item, such as by scanning an identification tag with a handheld scanner or manually entering a name or identification number, physical storage management program 108 may identify the selected item by consulting a pre-provided database of items, such as a commercial database of products offered by a store that the user is currently shopping at, and finding an entry for an item corresponding to the identifying information. The physical storage management program 108 may extract the dimensions and/or categories associated with the item from the entry associated with the item. In embodiments, for example where the physical storage management program 108 detected the user's selection of the item using image processing techniques, identifying the selected item may include extracting dimensions of the item based on image processing, and/or extracting a name or description or other identifying information from the packaging of the item using optical character recognition. Additionally, or alternatively, the identifying may comprise looking up the type of item in a pre-provided database of items based on the item detected using image processing techniques and/or optical character recognition and extracting categories and/or dimensions associated with the item.

In embodiments, dimensions of the item may comprise information relevant to how the item may fit into a finitely bounded space, such as the geometry, shape, size, volume, et cetera of the item. In embodiments of the invention, dimensions may further comprise dimensions of alternate states of the item; for example, the item selected by the user may be in a packaged state at the time of selection, but may be unpackaged for storage, such that the dimensions of the item may differ depending on whether the item is stored in a packaged or unpackaged state. Additionally, an item may possess the ability to be reconfigured into different states that are of differing dimensions; for example, an office chair may have arms that fold up, an adjustable seat height, and/or a removable base; each change to the configuration of the office chair may be considered a different state, because each change to the configuration changes the dimensions of the item. Any configuration or state of an item that changes the dimensions of the object from the original dimensions of the item at the time of selection may be referred to as a reconfiguration relative to the base state of the item. The physical storage management program 108 may retrieve not just the dimensions of the item at the time of selection, or base dimensions, but the dimensions of the item in some or all possible reconfigured and/or unpackaged states.

Categories may be metadata tags assigned to an item that indicate properties of the item that are relevant to selecting an appropriate storage area for the item. For example, items such as food, drinks, chemical compounds, et cetera that will spoil if they are not kept cool may be labeled with the category “perishable,” to indicate that such items need to be stored in a physical storage area that can be kept below a certain temperature, such as a refrigerator or freezer. In another example, items that will degrade if exposed to humidity, such as paper, antiques, pressed plants, et cetera may be labeled with the category “humidity sensitive” to indicate that such objects must be stored in a physical storage area that is humidity controlled.

At 204, the physical storage management program 108 may select storage areas suitable for storing the item based on a category associated with the item. Here, the physical storage management program 108 may consult the physical storage areas comprising the physical storage system to identify categories associated with the individual storage areas; categories associated with the individual storage areas may comprise categories of items that the storage areas are capable of storing. For example, climate-controlled storage areas such as refrigerators or freezers may be labeled with the category “perishable” to indicate that they can store perishable items. The physical storage management program 108 may select one or more suitable storage areas by comparing categories associated with an item against categories associated with the storage areas, and selecting all physical storage areas with categories that match all categories associated with the item. The categories associated with the physical storage areas may be provided by a user for example in response to a prompt provided by physical storage management program 108 when the physical storage area is first added to the storage system, retrieved from an external data repository such as a database, and/or pre-provided by an external source.

At 206, the physical storage management program 108 may determine an amount of storage space required to store the item based on dimensions of the item. Here, the physical storage management program 108 may utilize the dimensions of the item to calculate the shape and volume of the item, such that the physical storage management program 108 may determine whether the item can fit into a given physical storage space. In embodiments, for example where the dimensions include one or more reconfigured or unpackaged states, the physical storage management program 108 may determine an amount of storage space required to store the item in its base state as well as one or more reconfigured or unpackaged states.

At 208, the physical storage management program 108 may compare the amount of storage space required to store the item against the current amount of free storage space within the selected storage areas. Here, the physical storage management program 108 may consult the digital twin 107 to determine the current amount of storage space left in each of the selected physical storage areas, as well as the shape and volume of the available storage space, or free storage space, which may be measured in cubic inches and may be delineated as digital chunks. The physical storage management program 108 may then compare the required storage space against the free storage space of each selected physical storage area to determine if the item will fit in any of the selected physical storage areas. In embodiments, for example where the item comprises reconfigured and/or unpackaged states, if the remaining volume and shape of the free storage space is insufficient to fit in any of the selected storage areas, the physical storage management program 108 may iterate serially through the different states, comparing the storage space required for the item in each of the reconfigured and/or unpackaged states against the free storage space of each selected physical storage area to determine whether the item can fit into the selected physical storage area. In some embodiments, upon determining that an item can fit into a selected physical storage area, the physical storage management program 108 may add the item into the digital twin of the selected physical storage area as a previously stored object, such that the free storage space is reduced and the presence of the item is considered when determining whether subsequently selected items may be accommodated into the physical storage system.

At 210, the physical storage management program 108 may, responsive to identifying that the required amount of storage space exceeds the current amount of storage space based on the comparing, generate an alert to the user. If the physical storage management program 108 determines that none of the selected physical storage areas may accommodate the item in any of its states based on comparing the required storage space of the item against the free storage space available in each selected physical storage area, the physical storage management program 108 may transmit an alert to the user. The physical storage management program 108 may transmit the alert to an end user device 103 associated with the user, to be displayed on a display device and/or transmitted acoustically through speakers or a tactually via a haptic feedback device. The alert may comprise a graphical and/or audible message notifying the user that the selected item cannot fit within the user's storage system, and/or may comprise haptic feedback such as vibration. In some embodiments, the alert may further comprise a number enumerating a percentage of free storage space remaining in one or more of the physical storage areas, in all storage areas with matching categories such as refrigerators, and/or the physical storage system as a whole. In embodiments, for example where the user is equipped with an augmented reality device, the alert may comprise a graphical element overlaid onto a mixed-reality environment at a point within the user's field of view as determined based on a physical orientation of the mixed-reality device, or on or geographically proximate to the item or a virtual representation of the item.

In embodiments, the alert may further comprise a recommendation to not acquire the item, a recommendation to purchase a smaller-sized item, or a recommendation to acquire an alternate item of dimensions accommodated by the amount of free storage space available within the one or more selected storage areas or the physical storage system. The physical storage management program 108 may access a remote or pre-provided knowledge base of alternative products, select one or more alternatives to the item which are of dimensions sufficient to fit within available space of at least one compatible physical storage areas, and recommend the selected alternatives to the user in the generated alert. In embodiments, the physical storage management program 108 may notify the user of alternative packaging or medium of selected products.

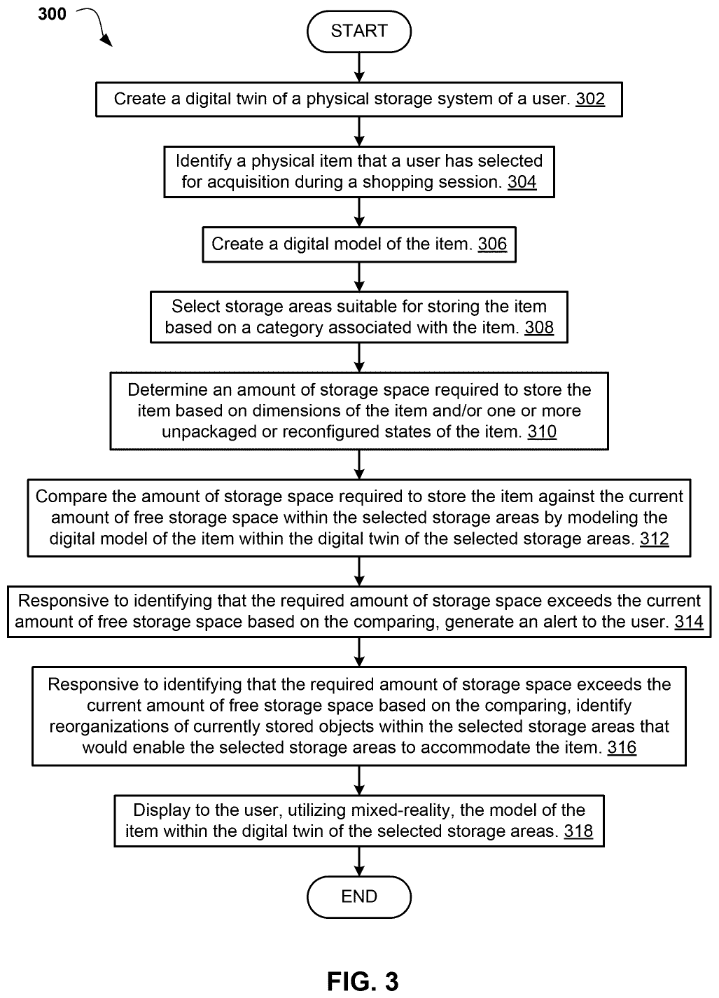

Referring now to FIG. 3, an operational flowchart illustrating a physical storage management process 300 is depicted according to at least one embodiment. At 302, the physical storage management program 108 may create a digital twin 107 of a physical storage system of a user. Here, the physical storage management program 108 receives initial data describing the physical storage system; the physical storage management program 108 may obtain initial data by receiving it from an external source, by receiving it from IoT sensors deployed within or otherwise recording sensor data on the physical storage areas, and/or by prompting a user to identify one or more physical storage areas to add into physical storage management program 108 to represent a single physical storage system; the physical storage management program 108 may prompt the user to enter categories associated with the physical storage areas describing what items the physical storage areas can store, and/or descriptions of the physical storage areas describing, for example, dimensions of the physical storage areas and physical objects that are already being stored within the physical storage areas, and/or names of the physical storage areas, such as “chest freezer,” “walk-in closet,” “trunk of car,” et cetera. Once the initial data has been acquired, the physical storage management program 108 may analyze sensor data from the one or more IoT devices within the physical storage areas to determine available space. The physical storage management program 108 may dynamically add or subtract digital representations of physical storage areas from the digital twin 107 of the physical storage system as new physical storage areas become available for use and previously added physical storage areas are no longer available for use. The physical storage management program 108 may update the digital twin 107 with sensor data in real time or near real time and/or at regular intervals, for example every second, every minute, every hour, et cetera. In some embodiments, physical storage management program 108 may update the digital twin 107 with sensor data when a shopping session is detected.

At 304, the physical storage management program 108 may identify a physical item that a user has selected for acquisition during a shopping session. Here, the physical storage management program 108 may recognize that the user has selected a physical item to acquire. In embodiments, the user may select a physical item by scanning an identification tag on the physical item with a handheld device, by entering a name and/or identification number for the object into physical storage management program 108, and/or by placing the item into a pre-designated location such as a shopping cart, checkout counter, shopping bag, et cetera in view of a camera. In embodiments, for example where the physical storage management program 108 uses mixed reality, the user may select an object by interacting with a virtual graphical and/or textual element overlayed onto or nearby to the physical item, or placed onto or near a digital representation of the physical item.

Once an item has been selected by the user, the physical storage management program 108 may identify the selected item. In embodiments, physical storage management program 108 may identify the selected item by looking up a name or identification number of an item in a pre-provided database of items, and finding an entry for an item corresponding to the identifying information. The physical storage management program 108 may extract the dimensions and/or categories associated with the item from the entry associated with the item. In embodiments, the physical storage management program 108 may identify the selected item by extracting dimensions of the item based on image processing, and/or extracting a name or description or other identifying information from the packaging of the item using optical character recognition.

In embodiments, dimensions of the item may comprise information relevant to how the item may fit into a finitely bounded space, such as the geometry, shape, size, volume, et cetera of the item. In embodiments of the invention, dimensions may further comprise dimensions of alternate states of the item; an item may possess the ability to be reconfigured into different states that are of differing dimensions, or may be removed from its packaging, resulting in an unpackaged state of differing dimensions from its original state at the time of selection. The physical storage management program 108 may retrieve not just the dimensions of the item at the time of selection, also referred to as an item's base dimensions, but also the dimensions of the item in some or all possible reconfigured and/or unpackaged states. In embodiments, categories may be metadata tags assigned to an item that indicate properties of the item that are relevant to selecting an appropriate storage area for the item.

A shopping session may comprise a contiguous period of time wherein the user is in the process of searching for a new item to acquire. A shopping session may be defined as a period where the user is present within a pre-defined geographic region, for example a region comprising a store, warehouse, market, et cetera, where a user is most likely to be shopping. The physical storage management program 108 may identify the location of the user based on the location of a user device 135, and may monitor the location of the user device 135 to identify whether the user enters one of the pre-defined geographic regions; upon determining that the user has entered one of the pre-defined geographic regions, the physical storage management program 108 may identify that a shopping session has been initiated. The physical storage management program 108 may terminate the shopping session when the user device 135 leaves the pre-defined geographic region that the user device 135 had previously entered, or when the user reaches a point of sale device. In embodiments of the invention, the physical storage management program 108 may identify all items selected during the shopping session.

At 306, the physical storage management program 108 may create a digital model of the item. Here, the physical storage management program 108 creates a digital representation of the item by constructing a virtual object with the same dimensions and properties of the item. In embodiments, the physical storage management program 108 may access a repository of digital models associated with different items; the physical storage management program 108 may retrieve a digital model corresponding to the item, and may modify the digital model to match the dimensions of the item. In embodiments, the physical storage management program 108 may create digital models for all items identified during the shopping session, and/or may create multiple digital models for an item, each representing a different state of an item. In embodiments of the invention, the model of the item may comprise a digital twin of the item.

At 308, the physical storage management program 108 may select storage areas suitable for storing the item based on a category associated with the item. Here, the physical storage management program 108 may consult the physical storage areas comprising the physical storage system to identify categories associated with the individual storage areas; categories associated with the individual storage areas may comprise categories of items that the storage areas are capable of storing. The physical storage management program 108 may select one or more suitable storage areas by comparing categories associated with an item against categories associated with the storage areas, and selecting all physical storage areas with categories that match all categories associated with the item. The categories associated with the physical storage areas may be provided by a user for example in response to a prompt provided by physical storage management program 108 when the physical storage area is first added to the storage system, retrieved from an external data repository such as a database, and/or pre-provided by an external source.

At 310, the physical storage management program 108 may determine an amount of storage space required to store the item based on dimensions of the item and/or one or more unpackaged or reconfigured states of the item. Here, the physical storage management program 108 may consult the digital model of the item to determine the shape and volume of the item, such that the physical storage management program 108 may determine whether the item can fit into a given physical storage space. The physical storage management program 108 may further determine an amount of storage space required to store the item in its one or more reconfigured or unpackaged states as well as its base state based on consulting the corresponding digital models of the items. In embodiments, the physical storage management program 108 may determine an amount of storage space required to store all items selected during the shopping session.

At 312, the physical storage management program 108 may compare the amount of storage space required to store the item against the current amount of free storage space within the selected storage areas by modeling the digital model of the item within the digital twin of the selected storage areas. Here, the physical storage management program 108 may create a simulation, or computer model, based on the digital twin 107, and may simulate the presence of the digital models of the item to determine whether the item or items will fit within the current amount of storage space left in each of the selected physical storage areas. In embodiments, for example where the item comprises reconfigured and/or unpackaged states, if the remaining volume and shape of the free storage space is insufficient to fit in any of the selected storage areas, the physical storage management program 108 may iterate serially through the different states, simulating the presence of the item in different states in determining whether the item can fit into the selected physical storage area.

In some embodiments, for example where there are multiple items, the physical storage management program 108 may simulate all items within the simulation of the digital twin 107 to determine whether all, a subset, or none of the items will fit within the selected physical storage areas, and if all cannot fit, may iterate through states of the different items to determine a combination of states and items that may be accommodated within the selected physical storage areas.

At 314, the physical storage management program 108 may, responsive to identifying that the required amount of storage space exceeds the current amount of storage space based on the comparing, generate an alert to the user. If the physical storage management program 108 determines that none of the selected physical storage areas may accommodate the item in any of its states based on comparing the required storage space of the item against the free storage space available in each selected physical storage area, the physical storage management program 108 may transmit an alert to the user. The physical storage management program 108 may transmit the alert to an end user device 103 associated with the user, to be displayed on a display device and/or transmitted acoustically through speakers or a tactually via a haptic feedback device. The alert may comprise a graphical and/or audible message notifying the user that the selected item cannot fit within the user's storage system, and/or may comprise haptic feedback such as vibration. In some embodiments, the alert may further comprise a number enumerating a percentage of free storage space remaining in one or more of the physical storage areas, in all storage areas with matching categories such as refrigerators, and/or the physical storage system as a whole. In embodiments, for example where the user is equipped with an augmented reality device, the alert may comprise a graphical element overlaid onto a mixed-reality environment at a point within the user's field of view as determined based on a physical orientation of the mixed-reality device, or on or geographically proximate to the item or a virtual representation of the item.

In embodiments, the alert may further comprise a recommendation to not acquire the item, a recommendation to purchase a smaller-sized item, or a recommendation to acquire an alternate item of dimensions accommodated by the amount of free storage space available within the one or more selected storage areas or the physical storage system. The physical storage management program 108 may access a remote or pre-provided knowledge base of alternative products, select one or more alternatives to the item which are of dimensions sufficient to fit within available space of at least one compatible physical storage areas, and recommend the selected alternatives to the user in the generated alert. In embodiments, the physical storage management program 108 may notify the user of alternative packaging or medium of selected products.

In some embodiments, for example where there are multiple selected items, the physical storage management program 108 may transmit an alert responsive to determining that some or all of the selected items cannot collectively fit within the selected physical storage areas; in other words. The physical storage management program 108 may identify a maximum number of the items which can be accommodated within the remaining free space based on the dimensions of the objects, and the alert may accordingly inform the user of the items that can be accommodated and the items that cannot be accommodated.

At 316, the physical storage management program 108 may, responsive to identifying that the required amount of storage space exceeds the current amount of free storage space based on the comparing, identify reorganizations of currently stored objects within the selected storage areas that would enable the selected storage areas to accommodate the item. If the physical storage management program 108 determines that none of the selected physical storage areas may accommodate the item in any of its states based on comparing the required storage space of the item against the free storage space available in each selected physical storage area, the physical storage management program 108 may identify reorganizations of currently stored objects within the selected storage areas. The physical storage management program 108 may identify the other physical objects stored within the selected physical storage areas through a variety of means, such as by comparing the provided dimensions of the physical storage area when empty against the current dimensions identified by IoT sensor data, by identifying objects by physical properties such as shape and appearance using IoT sensor data such as camera or LiDAR data, by accessing selected items from past shopping sessions and confirming that such past items were stored using IT sensor data, and/or by prompting the user to identify one or more other physical objects in a selected storage area. The physical storage management program 108 may then simulate at least the selected physical storage areas of the digital twin 107, including the stored physical objects within the selected physical storage areas, and may attempt to reposition the stored physical objects to increase the amount of free storage space within the selected physical storage areas in order to identify one or more physical configurations, or reorganizations, of stored physical objects and the item under which the physical storage area may be able to accommodate the item. In embodiments where there are multiple items, the physical storage management program 108 may identify one or more reorganizations that accommodate all items, or as many as possible.

At 318, the physical storage management program 108 may display to the user, utilizing mixed-reality, the model of the item within the digital twin 107 of the selected storage areas. Here, the physical storage management program 108 may render a graphical representation of the digital twin 107 within a mixed-reality environment, comprising for example a virtual or augmented reality environment, where the digital model of the item is rendered within any of the physical storage locations where the item may fit. In embodiments where there are multiple items, the physical storage management program 108 may render all digital models of the items where they fit; if all items cannot fit within the selected physical storage areas, the physical storage management program 108 may generate a model for each possible combination of stored items based on the free storage space and the required storage space for the items, and may allow a user to transition between and view the models of different combinations. In some embodiments, for example where physical storage management program 108 reorganizes the previously stored physical objects, the physical storage management program 108 may model the one or more reorganizations and allow the user to view them in the mixed reality environment. In embodiments, the mixed reality environment may enable the user to interact with and digitally manipulate the model, for example by moving representations of previously stored objects and/or items within and/or between representations of physical storage areas, reposition representations of physical storage areas within the user's vision, interact with representations of items to change their states, et cetera. In embodiments, the physical storage management program 108 may provide guidance to the user in organizing the item and the previously stored models. In some embodiments, the model of the digital twin 107 may comprise digital representations of one or more items that were previously selected for acquisition by the user, either prior to or during the current shopping session. Such items may be visually distinguished from previously stored physical objects, for example by being represented in a different color or with a highlighting effect.

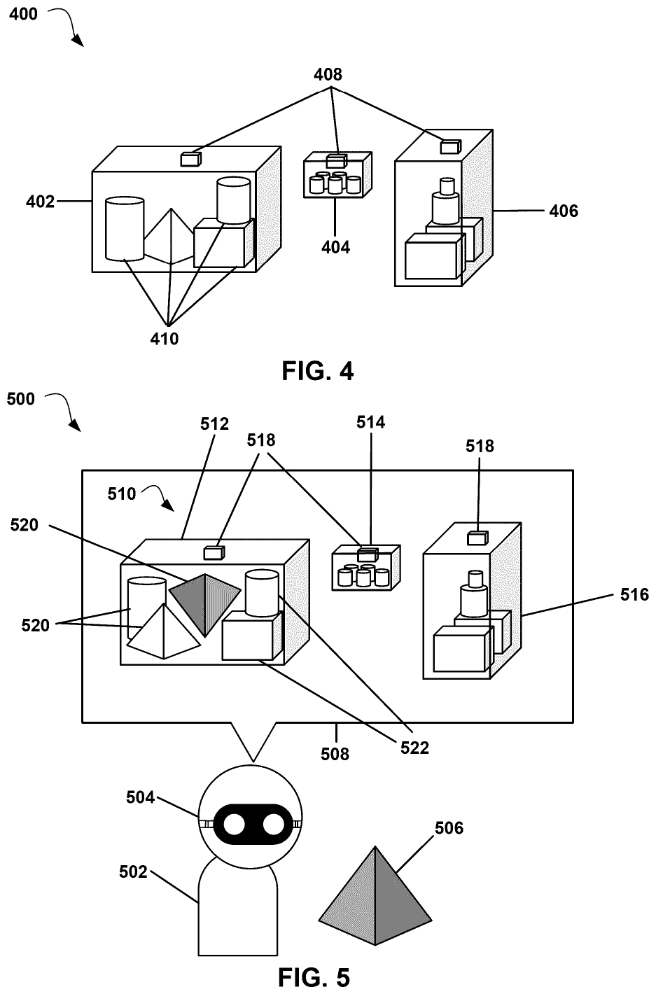

Referring now to FIG. 4, an exemplary physical storage system 400 is depicted according to at least one embodiment. Here, a physical storage system 400 of a user comprises three storage areas: a chest freezer 402, a cabinet 404, and a refrigerator 406. Each storage area further comprises an IoT device 408. Chest freezer 402 is currently storing a number of physical objects 410.

Referring now to FIG. 5, an exemplary use-case 500 of a physical storage management system implementing a physical storage management process 300 is depicted according to at least one embodiment. Here, a user 502 wearing a mixed-reality headset 504 is considering a physical item 506 for purchase in a store during a shopping session. The physical storage management program 108 uses image processing to identify the item 506 as a prism of tofu by matching it against images in a product database, and then retrieves category and dimensions information on item 506 from its database entry in the product database. The physical storage management program 108 then identifies the item 506 as belonging to the “perishable food” category and models the item 506 based on the retrieved dimensions. The physical storage management program 108 determines that the item 506 will not fit in the user's physical storage system 400, but could fit if already stored physical objects 410 were to be reorganized; the physical storage management program 108 communicates an alert to user 502, which apprises the user 502 of the need for reorganization and includes a button allowing the user to see the reorganization in a mixed-reality visualization 508. In response to the user 502 interacting with the button, the physical storage management program 108 visualizes to the user 502 an augmented reality environment 508 through the user's mixed-reality headset 504 describing the reorganization. The augmented reality environment 508 comprises a visualization of digital twin 107, which represents a physical storage system 400 comprising a chest freezer 402, a cabinet 404, and a refrigerator 406. The augmented reality environment 508 accordingly comprises a virtual representation 510 of the physical storage system 400, consisting of a digital representation 512 of chest freezer 402, a digital representation 514 of a cabinet 404, and a digital representation 516 of a refrigerator 406. The digital representations may further comprise digital representations 518 of the IoT devices 408, such that the digital representations are as faithful to the physical storage spaces they represent as possible.

The physical storage management program 108 identifies that item 506 is perishable, and therefore must be stored within either the chest freezer 402 or the refrigerator 406, which are associated with the “perishable food” category; the cabinet 404 is not associated with the “perishable food” category, because it is not climate controlled and item 506 will spoil if placed in the cabinet. Of the chest freezer 402 and refrigerator 406, neither has sufficient free space to accommodate item 506; however, physical storage management program 108 identifies that if real-world physical objects 410 already stored within the chest freezer 402 were to be reorganized, and if item 506 were to be stored upside-down, the chest freezer 402 could accommodate item 506. As such, the augmented reality environment 508 comprises a visualization of the reorganization necessary to accommodate item 506, which comprises a digital model 518 of item 506 within a representation 512 of chest freezer 402 along with virtual representations 520 of the real-world physical objects 410 positioned so as to allow item 506 to fit.

It may be appreciated that FIGS. 2-5 provide only illustrations of individual implementations and do not imply any limitations with regard to how different embodiments may be implemented. Many modifications to the depicted environments may be made based on design and implementation requirements. For example, in embodiments of the invention, some number of pre-determined items within a pre-determined location, such as products within a store, may be highlighted in augmented reality with colors corresponding to whether the user's physical storage system can accommodate the item; for example, if the user's physical storage system has run out of refrigerator space but still has cabinet space, perishable products may be highlighted in red while canned products may be highlighted in green. In further embodiments, the physical storage management program 108 may identify an expiration date of a selected item, and may prompt the user to remove the item from the physical storage system prior to or on the expiration date.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for managing a physical storage system of a user, the method comprising:
identifying a physical item that a user has selected for acquisition;
selecting one or more storage areas of a plurality of storage areas comprising the physical storage system to store the item in based on a category associated with the item;
determining an amount of storage space required to store the item based on dimensions of the item;
comparing the determined amount of storage space against a current amount of free storage space within the one or more selected storage areas; and
responsive to identifying that the determined amount of storage space exceeds the current amount of free space based on the comparing, generating an alert to the user.

2. The method of claim 1, wherein the alert includes a recommendation to not purchase the item, a recommendation to purchase a smaller sized item, or a recommendation to purchase an alternate item of dimensions accommodated by the amount of free storage space within the one or more selected storage areas or the physical storage system.

3. The method of claim 1, further comprising:
responsive to identifying that the determined amount of storage space exceeds the current amount of free space based on the comparing, identifying one or more reorganizations of one or more currently stored objects within the one or more selected storage areas that would enable the one or more selected storage areas to accommodate the item.

4. The method of claim 1, further comprising: utilizing mixed-reality to display to the user the selected item within the selected one or more storage areas.

5. The method of claim 1, wherein the determining further comprises:
determining an amount of storage space required to store the item in an unpackaged or reconfigured state.

6. The method of claim 1, wherein the comparing further comprises:
generating a digital model of the item based on the dimensions; and modeling the digital model of the item within a digital twin of the selected one or more storage areas, wherein the digital twin of the selected one or more storage areas comprises one or more currently stored objects.

7. The method of claim 6, wherein the digital twin of the selected one or more storage areas comprises one or more other items previously selected for acquisition by the user.

8. A computer system for managing a physical storage system of a user, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
identifying a physical item that a user has selected for acquisition;
selecting one or more storage areas of a plurality of storage areas comprising the physical storage system to store the item in based on a category associated with the item;
determining an amount of storage space required to store the item based on dimensions of the item;
comparing the determined amount of storage space against a current amount of free storage space within the one or more selected storage areas; and
responsive to identifying that the determined amount of storage space exceeds the current amount of free space based on the comparing, generating an alert to the user.

9. The computer system of claim 8, wherein the alert includes a recommendation to not purchase the item, a recommendation to purchase a smaller sized item, or a recommendation to purchase an alternate item of dimensions accommodated by the amount of free storage space within the one or more selected storage areas or the physical storage system.

10. The computer system of claim 8, further comprising:
responsive to identifying that the determined amount of storage space exceeds the current amount of free space based on the comparing, identifying one or more reorganizations of one or more currently stored objects within the one or more selected storage areas that would enable the one or more selected storage areas to accommodate the item.

11. The computer system of claim 8, further comprising: utilizing mixed-reality to display to the user the selected item within the selected one or more storage areas.

12. The computer system of claim 8, wherein the determining further comprises:
determining an amount of storage space required to store the item in an unpackaged or reconfigured state.

13. The computer system of claim 8, wherein the comparing further comprises:
generating a digital twin of the item based on the dimensions; and modeling the digital twin of the item within a digital twin of the selected one or more storage areas, wherein the digital twin of the selected one or more storage areas comprises one or more currently stored objects.

14. The computer system of claim 13, wherein the digital twin of the selected one or more storage areas comprises one or more other items previously selected for acquisition by the user.

15. A computer program product for managing a physical storage system of a user, the computer program product comprising:
one or more computer-readable tangible storage medium and program instructions stored on at least one of the one or more tangible storage medium, the program instructions executable by a processor to cause the processor to perform a method comprising:
identifying a physical item that a user has selected for acquisition;
selecting one or more storage areas of a plurality of storage areas comprising the physical storage system to store the item in based on a category associated with the item;
determining an amount of storage space required to store the item based on dimensions of the item;
comparing the determined amount of storage space against a current amount of free storage space within the one or more selected storage areas; and
responsive to identifying that the determined amount of storage space exceeds the current amount of free space based on the comparing, generating an alert to the user.

16. The computer program product of claim 15, wherein the alert includes a recommendation to not purchase the item, a recommendation to purchase a smaller sized item, or a recommendation to purchase an alternate item of dimensions accommodated by the amount of free storage space within the one or more selected storage areas or the physical storage system.

17. The computer program product of claim 15, further comprising:
responsive to identifying that the determined amount of storage space exceeds the current amount of free space based on the comparing, identifying one or more reorganizations of one or more currently stored objects within the one or more selected storage areas that would enable the one or more selected storage areas to accommodate the item.

18. The computer program product of claim 15, further comprising: utilizing mixed-reality to display to the user the selected item within the selected one or more storage areas.

19. The computer program product of claim 15, wherein the determining further comprises:
determining an amount of storage space required to store the item in an unpackaged or reconfigured state.

20. The computer program product of claim 15, wherein the comparing further comprises:
generating a digital twin of the item based on the dimensions; and modeling the digital twin of the item within a digital twin of the selected one or more storage areas, wherein the digital twin of the selected one or more storage areas comprises one or more currently stored objects.
